(19) United States
(12) Patent Application Publication
(10) Pub. No.: US 2021/0176223 A1
(43) Pub. Date: Jun. 10, 2021

(54) APPARATUS AND METHOD FOR TRANSMITTING DATA BETWEEN A FIRST AND A SECOND NETWORK

(71) Applicant: Siemens Mobility GmbH, München, Bayern (DE)

(72) Inventor: Rainer Falk, Poing (DE)

(21) Appl. No.: 16/769,619

(22) PCT Filed: Nov. 15, 2018
(86) PCT No.: PCT/EP2018/081294

§ 371 Date: Jun. 4, 2020

(30) Foreign Application Priority Data
Dec. 18, 2017 (DE) 10 2017 223 099.1

(51) Int. Cl. H04L 29/06

(52) U.S. Cl. CPC H04L 63/0471; H04L 9/0844; H04L 63/18

(57) ABSTRACT

Provided is a device for transmitting data between a first and a second network, including: a first one-way communication path solely for transmitting data from the first to the second network, including a first data diode and an encryption device for cryptographically encrypting the data to be transmitted from the first to the second network; and a second one-way communication path solely for transmitting data from the second to the first network, including a second data diode and a decryption device for cryptographically decrypting the data to be transmitted from the second to the first network. Data can be transmitted with an increased degree of security between the first and the second network

### CROSS-REFERENCE TO RELATED APPLICATIONS

This application claims priority to PCT Application No. PCT/EP2018/081294, having a filing date of Nov. 15, 2018, which is based on DE Application No. 10 2017 223 099.1, having a filing date of Dec. 18, 2017, the entire contents both of which are hereby incorporated by reference.

### FIELD OF TECHNOLOGY

The following relates to an apparatus for transmitting data between a first and a second network and to a method for transmitting data between the first and the second network.

### BACKGROUND

In some systems, for example in industrial systems, it may be desirable to transmit data between a first and a second network of the system. In order to protect critical systems, encryption and/or decryption of the data may be desirable for the data transmission. There is a need to encrypt and/or decrypt the data reliably in order to ensure the security of the system.

The document U.S. Pat. No. 8,531,247 B2, the document U.S. Pat. No. 8,892,616 B2, the document U.S. Pat. No. 8,300,811 B2, the document U.S. Pat. No. 9,147,088 B2, the document U.S. Pat. No. 9,584,311 B2, the document EP 2976707 B1, the document EP 2 605 445 B1, the document EP 2 870 565 A1, the document EP 2 891 102 A1, the document WO 2017137256 A1, the document EP 2870565 B1, the document EP 3028140 B1, the document EP 17175275 and the document U.S. Pat. No. 8,843,761 B2 are known from the conventional art.

### SUMMARY

An aspect relates to an improved transmission of data between a first and a second network.

According to a first aspect, an apparatus for transmitting data between a first and a second network is proposed. The apparatus comprises:

a first one-way communication path for exclusively transmitting data from the first to the second network, having a first data diode and an encryption device for cryptographically encrypting the data to be transmitted from the first to the second network; and

a second one-way communication path for exclusively transmitting data from the second to the first network, having a second data diode and a decryption device for cryptographically decrypting the data to be transmitted from the second to the first network.

The first and the second network, also referred to together as “networks” below, are in particular systems that each comprise multiple interconnected devices. The networks can be for example industrial networks, control networks, automation networks, process networks, private networks and/or public networks. In embodiments, the first network is an industrial network and the second network is a public network, such as e.g. the Internet. The two networks can be part of the same environment or the same system, for example an industrial system. In individual cases, a network can also contain just a single device, e.g. a network-compatible machine tool or a robot.

The data can be any data, e.g. control data. The data are in particular security-relevant data. The apparatus for transmitting the data between the networks, also “transmission apparatus” below, may be suited to transmitting data bidirectionally, i.e. to transmitting data both from the first to the second network and from the second to the first network. The transmission apparatus can also be referred to as a communication interface of the first network for communication with the second network. It is also possible to refer to the transmission apparatus as an encryption device.

To transmit the data from the first to the second network, the transmission apparatus comprises the first one-way communication path, which can also be referred to as a first one-way communication link. The first one-way communication path is used for exclusively transmitting/sending data from the first to the second network and therefore allows in particular just unidirectional data transmission from the first to the second network. In particular, all data transmitted from the first to the second network are transmitted via the first one-way communication path. The first one-way communication path comprises in particular a cable for data transmission that connects the first data diode and the encryption device to one another. The cable can be an electrical cable, e.g. a twisted pair line or a coaxial cable, an optical cable (optical fiber) or a waveguide.

The first data diode, which is part of the first one-way communication path, is in particular a device that passes data just in one predetermined direction. It can also be referred to as a unidirectional interface. The first data diode is closed to data transmitted to the data diode contrary to the predetermined direction. The first data diode is oriented in the first one-way communication path in particular such that it can pass only data from the first to the second network. The first data diode can in particular prevent data sent from the second to the first network from being transmitted via the first one-way communication path. In particular, all data transmitted from the first to the second network must pass through the first data diode. The data diode can be e.g. a physical data diode that allows data transmission physically only in one direction (e.g. comprising an optical data transmitting apparatus and an optical data receiving apparatus) or a network monitoring device, also referred to as a network tap.

The encryption device, which is also part of the first one-way communication path, can be used for cryptographically encrypting the data transmitted from the first to the second network. In particular all data transmitted from the first to the second network are encrypted by the encryption device. The encryption device can have an encryption key, in particular a private, secret encryption key or a public encryption key for the purpose of data encryption. The encryption device can be used for example to ensure that all data sent from the first network are properly cryptographically protected so that they cannot be read by devices unauthorized to do so.

To transmit the data from the second to the first network, the transmission apparatus comprises the second one-way communication path, which can also be referred to as a second one-way communication link. The second one-way communication path is used for exclusively transmitting/sending data from the second to the first network and therefore allows in particular just unidirectional data transmission from the second to the first network. In particular, all data transmitted from the second to the first network are transmitted via the second one-way communication path. The second one-way communication path comprises in particular a cable for data transmission that connects the second data diode and the decryption device to one another.

The second data diode, which is part of the first one-way communication path, is in particular in a form analogous to that of the first data diode, that is to say in the form of a device that passes data just in one predetermined direction. It can also be referred to as a unidirectional interface. The second data diode is closed to data transmitted to the data diode contrary to the predetermined direction. The second data diode is oriented in the second one-way communication path in particular such that it can pass only data from the second to the first network. The second data diode can in particular prevent data sent from the first to the second network from being transmitted via the second one-way communication path. In particular, all data transmitted from the second to the first network must pass through the second data diode.

The first and the second data diode, also referred to together as “data diodes” below, can also be in the form of a network tap. The network tap has for example the property that it is open only to data in one predetermined direction. Additionally, inspection of the data to be transmitted may be possible.

The decryption device, which is also part of the second one-way communication path, can be used for cryptographically decrypting the data transmitted from the second to the first network. In particular all data transmitted from the second to the first network are decrypted by the decryption device. The decryption device can be used e.g. to ensure that all data entering the first network were properly encrypted and come from an approved sender. The decryption device can have a decryption key, in particular a private decryption key, for the purpose of data decryption. The encryption key of the encryption device and the decryption key of the decryption device can be negotiated in a key negotiation method. The encryption key and the decryption key can form corresponding keys of a key pair. In a variant, the decryption key is a public key of a communication partner, i.e. of a second apparatus, the decryption key is the private key of the first apparatus itself. It is likewise possible for the encryption key to be a first secret symmetrical key and for the decryption key to be a second secret key. It is possible for the encryption key and the decryption key to be derived from a common master session key. The master session key can be formed by means of an authentication and key agreement protocol, e.g. IKEv2 or TLS Authentication and Key Agreement, using long-lasting keys. It is furthermore possible for the decryption key and the encryption key to be formed or set up independently of one another.

As a result of the transmission apparatus having two separate one-way communication paths, there is the assurance that all data transmitted from the first to the second network are encrypted using the encryption device of the first one-way communication path, and that all data transmitted from the second to the first network are decrypted using the decryption device of the second one-way communication path. As a result, it is possible to ensure that all data entering the first network from the second network are properly decrypted by the decryption device, and that all data leaving the first network for the second network are properly encrypted by the encryption device. The transmission apparatus therefore forms protection for the first network, in particular.

As a result of the first one-way communication path with the first data diode being in the form of a one-way communication link, it is possible for example to prevent attack data generated during an attack on the second network, for example, from being transmitted in the direction of the first network and jeopardizing the security of the first network. An attack is understood to mean a hack attack, in particular.

As a result of the second one-way communication path with the second data diode being in the form of a one-way communication link, it is possible for example to prevent attack data generated during an attack on the first network, for example, from being transmitted in the direction of the second network and jeopardizing the security of the second network.

It is furthermore possible to ensure that all data sent by the first network are encrypted so that they can be read only by approved receivers. Moreover, it is possible to ensure that all data arriving in the first network were encrypted properly beforehand and were transmitted by a reliable sender. The transmission apparatus therefore makes a particular contribution to the security of the first network. In embodiments, the transmission apparatus is part of the first network.

The transmission apparatus can therefore in particular increase the security of the data transmission and is employable in critical systems in which the first and/or second network is/are used to transmit security-relevant, in particular safety-relevant, data. The transmission apparatus can be used to create a reaction-free data transmission between the first and the second network.

The components needed for compiling the transmission apparatus are in particular known, widely used components. This allows the transmission apparatus to be manufactured inexpensively, because no new components need to be developed and manufactured.

According to one embodiment, the first and the second one-way communication path are physically and/or logically separate from one another. In particular, no data can be transmitted/interchanged between the first and the second one-way communication path.

According to another embodiment, the first data diode is connected in series upstream or connected in series downstream of the encryption device along the first one-way communication path.

According to another embodiment, the second data diode is connected in series upstream or connected in series downstream of the decryption device along the second one-way communication path.

Connecting the first data diode in series upstream of the encryption device is advantageous in particular because this makes it possible to prevent attack data generated during an attack on the encryption device from being transmitted in the direction of the first network and jeopardizing the security of the first network. Put another way, it is possible to prevent data from being sent to the first network by the encryption device.

Similarly, it is in particular advantageous to connect the second data diode in series upstream of the decryption device because this makes it possible to prevent attack data generated during an attack on the decryption device from being transmitted in the direction of the second network and jeopardizing the security of the second network. Put another way, it is possible to prevent data from being sent to the second network by the decryption device.

According to another embodiment, the first one-way communication path comprises multiple first data diodes. According to another embodiment, the second one-way communication path comprises multiple second data diodes.

Each first data diode has in particular the properties of the first data diode that are described above. Each second data diode has in particular the properties of the second data diode that are described above. Providing multiple data diodes in a one-way communication path can serve to prevent data from being transmitted in the direction that is closed by the data diodes in individual sections of the one-way communication paths. This allows individual elements of the communication paths, for example the encryption device and/or the decryption device, and the networks to be protected from attacks.

According to another embodiment, at least one first data diode of the multiple first data diodes is connected in series upstream of the encryption device along the first one-way communication path and at least one further first data diode of the multiple first data diodes is connected in series downstream of the encryption device along the first one-way communication path. According to another embodiment, at least one second data diode of the multiple second data diodes is connected in series upstream of the decryption device along the second one-way communication path and at least one further second data diode of the multiple second data diodes is connected in series downstream of the decryption device along the second one-way communication path.

A first data diode can be connected upstream and a first data diode can be connected downstream of the encryption device. The effect that can be achieved thereby is that data transmitted in the direction from the second to the first network, e.g. attack data, can be transmitted neither to the encryption device nor to the first network via the first one-way communication path. As a result, the encryption device and the first network are protected from attacks on different points in the first one-way communication path.

It is also possible for a second data diode to be connected upstream and for a second data diode to be connected downstream of the decryption device. The effect that can be achieved thereby is that data transmitted in the direction from the first to the second network, e.g. attack data, can be transmitted neither to the decryption device nor to the second network via the second one-way communication path. As a result, the decryption device and the second network are protected from attacks on different points in the second one-way communication path.

According to another embodiment, the apparatus comprises at least one further encryption device, which is part of the first one-way communication path. According to another embodiment, the apparatus comprises at least one further decryption device, which is part of the second one-way communication path.

The further encryption device is in particular in a form like the encryption device described above and set up to cryptographically encrypt data transmitted from the first to the second network. To this end, the further encryption device can have a further encryption key. The further encryption device is for example connected in series upstream or downstream of the encryption device along the first one-way communication path. The further encryption device can be implemented differently than and/or independently of the encryption device described above.

The encryption device and the further encryption device allow in particular double encryption with different implementations. If one of the encryption devices does not encrypt the data properly, the encryption of the data is ensured by the other encryption device. This allows the security of the data transmission to be increased, because the data are encrypted even if one of the encryption devices is attacked. The transmission apparatus can have any number of such further encryption devices.

The further decryption device is in particular in a form like the decryption device described above and set up to cryptographically decrypt data transmitted from the second to the first network. To this end, the further decryption device can have a further decryption key. The further decryption device is for example connected in series upstream or downstream of the decryption device along the second one-way communication path. The further decryption device can be implemented differently than and/or independently of the decryption device described above.

The decryption device and the further decryption device allow in particular double decryption with different implementations. If one of the decryption devices does not decrypt the data properly, the decryption of the data is ensured by the other decryption device. This allows the security of the data transmission to be increased, because the data are decrypted properly even if one of the decryption devices is attacked. The transmission apparatus can have any number of such further decryption devices.

According to another embodiment, at least one first data diode is arranged in series between the two encryption devices. According to another embodiment, at least one second data diode is arranged in series between the two decryption devices.

As a result of there being provision for a data diode between two encryption devices and/or between two decryption devices, it is possible to prevent attack data from being transmitted from the encryption device and/or decryption device connected downstream along the one-way communication path to the upstream encryption device and/or decryption device. This allows the security of the data transmission to be increased.

According to another embodiment, the first network is a private network. According to another embodiment, the second network is a public network.

According to another embodiment, the first one-way communication path comprises a first data handling device for handling the data transmitted from the first to the second network. According to another embodiment, the second one-way communication path comprises a second data handling device for handling the data transmitted from the second to the first network.

The first and second data handling devices, also “data handling devices” below, comprise for example applications that handle and/or process transmitted data, for example in order to perform a data analysis. In embodiments, the encryption device and/or the decryption device are part of the data handling device, and/or the encryption device and/or the decryption device are embodied as the data handling device.

According to another embodiment, the apparatus furthermore comprises a control device for setting up the encryption device and/or the decryption device. The control device can use the key negotiation method, for example, to negotiate the encryption keys and decryption keys for the encryption device and the decryption device.

According to a second aspect, a method for transmitting data between a first and a second network is proposed. The method comprises:

exclusively transmitting data from the first to the second network via a first one-way communication path having a first data diode and an encryption device for cryptographically encrypting the data to be transmitted from the first to the second network; and

exclusively transmitting data from the second to the first network via a second one-way communication path having a second data diode and a decryption device for cryptographically decrypting the data to be transmitted from the second to the first network.

According to one embodiment, the method is performed using the apparatus according to the first aspect or according to an embodiment of the first aspect.

The embodiments and features described for the proposed apparatus apply to the proposed method accordingly.

Furthermore, a computer program product (non-transitory computer readable storage medium having instructions, which when executed by a processor, perform actions) is proposed that prompts the performance of the method according to the second aspect or according to an embodiment of the second aspect on a program-controlled device.

A computer program product, such as e.g. a computer program means, can be provided or supplied for example as a storage medium, such as e.g. a memory card, USB stick, CD-ROM, DVD, or else in the form of a downloadable file from a server in a network. This can take place for example in a wireless communication network by means of the transmission of the appropriate file with the computer program product or the computer program means.

Other possible implementations of embodiments of the invention also comprise combinations that are not explicitly cited of features or embodiments described above or below for the exemplary embodiments. A person skilled in the art will also add individual aspects as improvements or additions to the respective basic form of embodiments of the invention.

### BRIEF DESCRIPTION

Some of the embodiments will be described in detail, with reference to the following figures, wherein like designations denote like members, wherein:

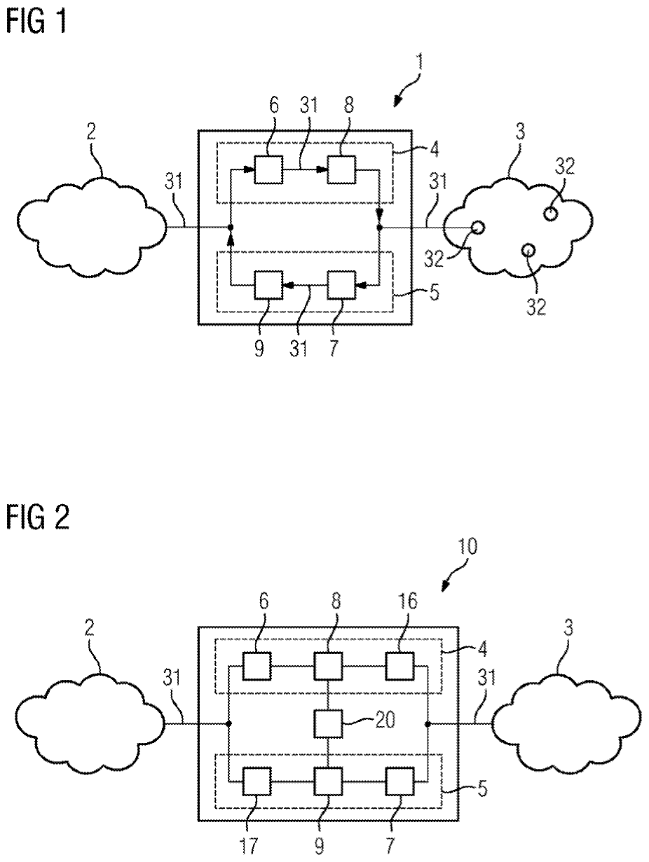

FIG. 1 shows an apparatus for transmitting data between a first and a second network according to a first embodiment;

FIG. 2 shows an apparatus for transmitting data between a first and a second network according to a second embodiment;

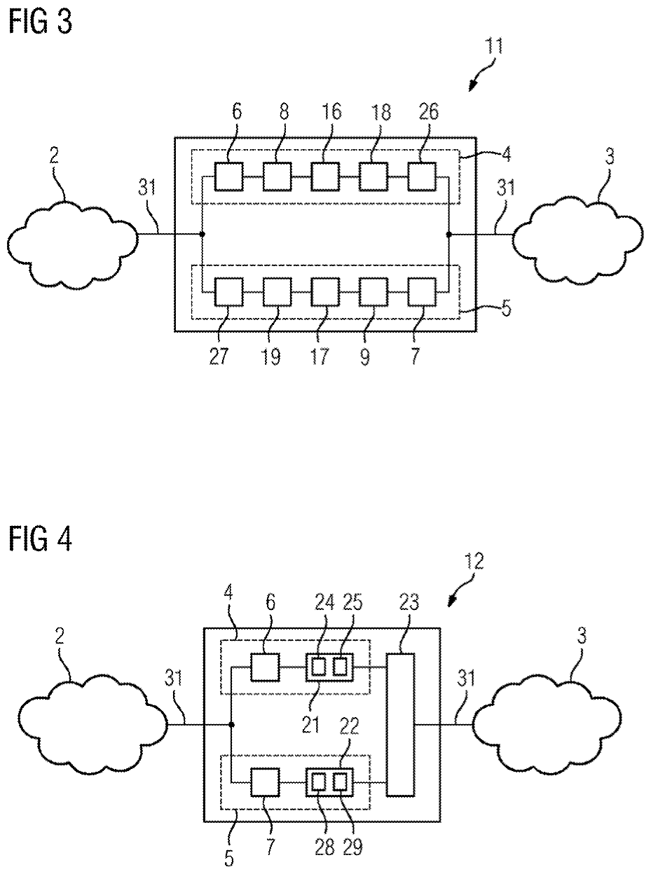

FIG. 3 shows an apparatus for transmitting data between a first and a second network according to a third embodiment;

FIG. 4 shows an apparatus for transmitting data between a first and a second network according to a fourth embodiment;

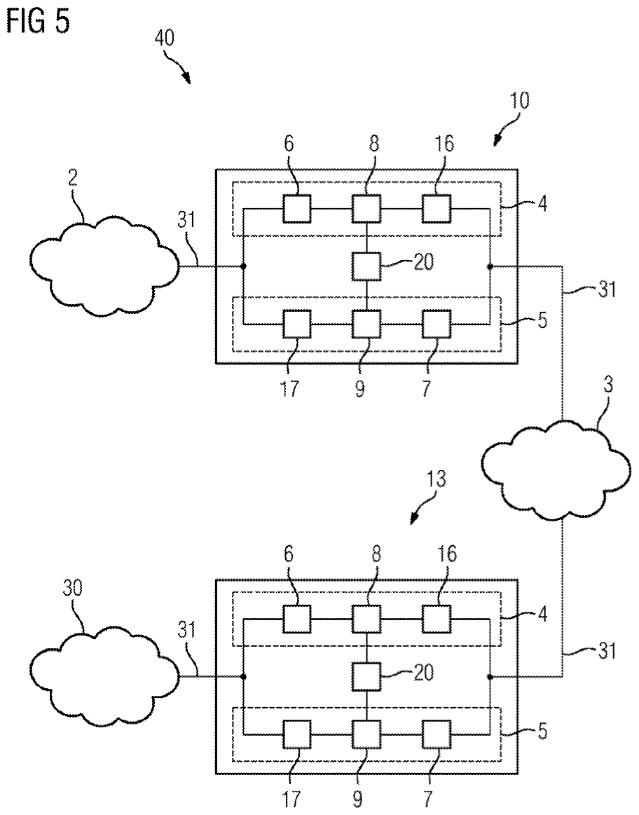

FIG. 5 shows a first example of a transmission system;

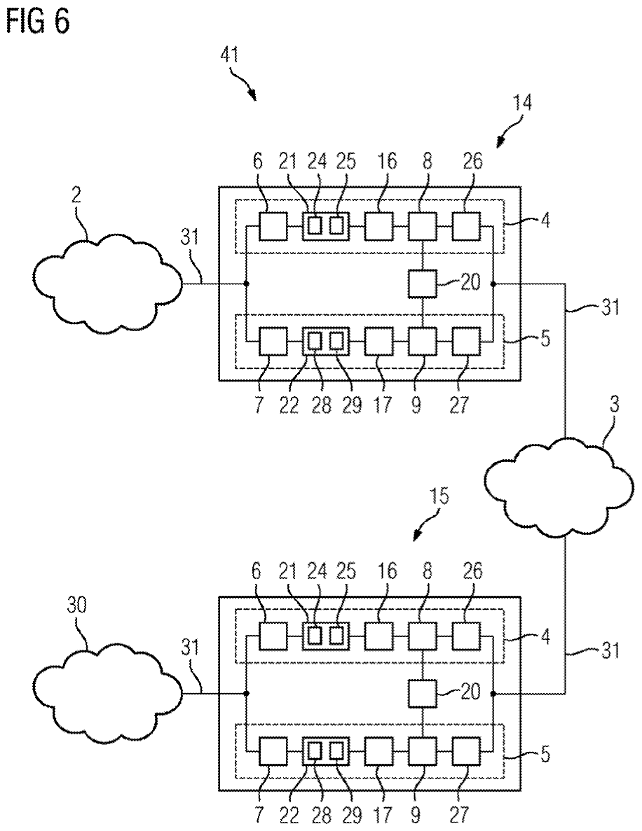

FIG. 6 shows a second example of a transmission system; and

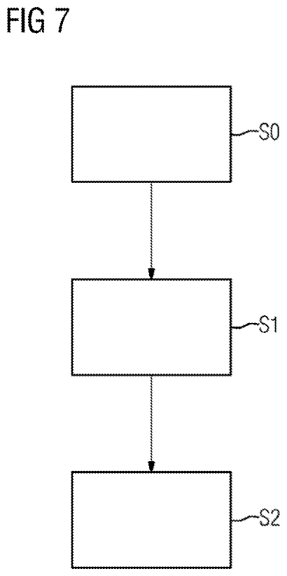

FIG. 7 shows a method for transmitting data between a first and a second network according to an embodiment.

### DETAILED DESCRIPTION

FIG. 1 shows an apparatus 1 for transmitting data between a first and a second network 2, 3 according to a first embodiment. The first network 2 is an industrial control network used for controlling production machines, not depicted. The second network 3 is a public network in the form of an Internet of Things network. The second network 3 has multiple Internet of Things interfaces 32 for the purpose of data interchange with multiple networks.

Data are interchanged between the first and the second network 2, 3, this taking place exclusively via the apparatus 1. The data transmitted from the first network 2 to the second network 3 are in particular production data and/or sensor data describing the production by the production machines of the first network 2. The data transmitted from the second network 3 to the first network 2 are e.g. control data for actuating the production machines of the first network 2.

The apparatus 1 is connected between the two networks 2, 3 by means of cables 31. The apparatus 1 has a first one-way communication path 4, used for exclusively transmitting data from the first network 2 to the second network 3, and a second one-way communication path 5, used for exclusively transmitting data from the second network 3 to the first network 2.

The first one-way communication path 4 comprises a first data diode 6 and an encryption device 8, wherein the first data diode 6 is connected upstream of the encryption device 8 along the first one-way communication path 4. The first data diode 6 can pass only data that are transmitted from the first to the second network 2, 3. The first data diode 6 is closed to data transmitted from the second network 3 to the first network 2. Within the first one-way communication path 4, the first data diode 6 and the encryption device 8 are connected to one another via a cable 31.

The encryption device 8 has an encryption key that it can use to cryptographically encrypt the data transmitted from the first network 2 to the second network 3. This prevents secret data from being sent unprotected to devices arranged outside the first network 2.

If the encryption device 8 is damaged by a hacker attack, the first one-way communication path 4 cannot be used to transmit attack data resulting from the attack to the first network 2, which protects the first network 2.

The second one-way communication path 5 comprises a second data diode 7 and a decryption device 9, wherein the second data diode 7 is connected upstream of the decryption device 9 along the second one-way communication path 5. The second data diode 7 can pass only data that are transmitted from the second to the first network 3, 2. The second data diode 7 is closed to data transmitted from the first network 2 to the second network 3. Within the second one-way communication path 5, the second data diode 7 and the decryption device 9 are connected to one another via a cable 31.

The decryption device 9 has a decryption key that it can use to cryptographically decrypt the data transmitted from the second network 3 to the first network 2. This ensures that all data received by the second network 3 were encrypted properly and come from a reliable sender.

If the decryption device 9 is damaged by a hacker attack, the second one-way communication path 5 cannot be used to transmit attack data resulting from the attack to the second network 3, which also protects the second network 3.

In FIG. 1, the direction of the data interchange within the apparatus 1 is depicted schematically by arrows.

FIG. 2 shows an apparatus 10 for transmitting data between a first and a second network 2, 3 according to a second embodiment. The apparatus 10 according to the second embodiment differs from the apparatus 1 according to the first embodiment, depicted in FIG. 1, in that the first one-way communication path 4 has an additional first diode 16, and in that the second one-way communication path 5 has an additional second diode 17.

As depicted in FIG. 2, the encryption device 8 is connected in series between the two first data diodes 6, 16 along the first one-way communication path 4. The arrangement of the additional first data diode 16 in the first one-way communication path 4 prevents data transmitted from the second network 3 to the first network 2 from being able to reach the encryption device 8 in the first place.

The decryption device 9 is connected in series between the two second data diodes 7, 17 along the second one-way communication path 5. The arrangement of the additional second data diode 17 in the second one-way communication path 5 prevents data transmitted from the first network 2 to the second network 3 from being able to reach the decryption device 9 in the first place.

The apparatus 10 furthermore has a control device 20 for setting up the encryption device 8 and the decryption device 9. The control device 20 is used to generate the encryption key and the decryption key. The encryption key and the decryption key can be generated when the encryption device 8 and the decryption device 9 are initialized.

FIG. 3 shows an apparatus 11 for transmitting data between a first and a second network 2, 3 according to a third embodiment. The apparatus 11 according to the third embodiment differs from the apparatus 1, 10 according to the first and second embodiments by virtue of the components provided in the first and second one-way communication paths 4, 5.

The first communication path 4 comprises the first data diode 6, the encryption device 8, the first data diode 16, a further encryption device 18 and a further first data diode 26, which are arranged in series in that order along the first communication path 4. The second communication path 5 comprises the second data diode 7, the decryption device 9, the second data diode 17, a further decryption device 19 and a further second data diode 27, which are arranged in series in that order along the second communication path 5.

Providing two encryption devices 8, 18 serves to ensure the encryption of the data transmitted from the first network 2 to the second network 3 even if one of the encryption devices 8, 18 fails or is attacked. Providing two decryption devices 9, 19 serves to ensure the decryption of the data transmitted from the second network 3 to the first network 2 even if one of the decryption devices 9, 19 fails or is attacked. This makes it possible to ensure that the data are always properly encrypted/decrypted by the apparatus 11.

The three data diodes 6, 7, 16, 17, 26, 27 provided in the respective one-way communication paths 4, 5 increase the security of the data transmission, because the data transmission can take place in reaction-free fashion.

FIG. 4 shows an apparatus 12 for transmitting data between a first and a second network 2, 3 according to a fourth embodiment. The apparatus 12 according to the fourth embodiment differs from the apparatuses 1 according to the first embodiment in that the first one-way communication path 4 has a first data handling device 21 and the second one-way communication path 5 has a second data transmission device 22.

The first data handling device 21 is connected downstream of the first data diode 6 in the first one-way communication channel 4. It comprises two applications 24, 25 that evaluate the data transmitted from the first network 2 to the second network 3. To this end, the applications 24, 25 perform calculations on the data. The data handling device 21 is also used for encrypting the data and is therefore in the form of an encryption device 6, which is also suitable for data processing.

The second data handling device 22 is connected downstream of the second data diode 7 in the second one-way communication channel 5. It also comprises two applications 28, 29 that evaluate the data transmitted from the second network 3 to the first network 2. To this end, the applications 28, 29 perform calculations on the data and check whether the data come from a reliable sender. The data handling device 22 is also used for decrypting the data and is therefore in the form of a decryption device 7, which is also suitable for data processing.

The apparatus 12 according to the fourth embodiment moreover comprises a bidirectional interface 23 that is able both to send data to the second network 3 and to receive data from the second network 3.

FIG. 5 shows a first example of a transmission system 40. The transmission system 40 is used for transmitting data between the first network 2 and a further network 30 via the second network 3. The transmission system 40 to this end comprises in particular the apparatus 10 according to the second embodiment, which has been described with reference to FIG. 2, and a further apparatus 13, which is in a form analogous to that of the apparatus 10.

Data transmission from the first network 2 to the further network 30 is accomplished by first of all transmitting data from the first network 2 to the second network 3 via the apparatus 10, and then transmitting the data from the second network 3 to the further network 30 via an apparatus 13. A data transmission from the further network 30 to the first network 2 takes place in precisely the opposite manner.

The further network 30 of the transmission system 40 can be in the form of an industrial network. In the configuration of the transmission system 40, the apparatuses 10, 13 are in the form of VPN (virtual private network) interfaces for the networks 2, 30.

The transmission system 40 allows particularly secure data transmission between the networks 2 and 30 using the apparatuses 10, 13.

FIG. 6 shows a second example of a transmission system 41. The transmission system 41 is used for transmitting data between the first network 2 and the further network 30 via the second network 3. The transmission system 41 according to the second example differs from the transmission system 40 according to the first example from FIG. 5 in that it has the apparatuses 14 and 15 instead of the apparatuses 10 and 13.

The apparatuses 14, 15 are in a form analogous with respect to one another. They comprise a combination of the components described with reference to the apparatuses 1, 10-13 of FIGS. 1-5.

The first one-way communication path 4 of the apparatuses 14, 15 comprises the first data diode 6, the first data handling device 21, the first data diode 16, the encryption device 8 and the first data diode 26, which are arranged in series in that order along the first communication path 4. The second communication path 5 comprises the second data diode 27, the decryption device 9, the second data diode 17, the second data handling device 22 and the second data diode 7, which are arranged in series in that order along the second communication path 5. Furthermore, the apparatuses 14, 15 each have a control device 20.

Similarly, to the transmission system 40 from FIG. 5, the transmission system 40 allows particularly secure data transmission between the networks 2 and 30 using the apparatuses 10, 13.

FIG. 7 shows a method for transmitting data between a first and a second network 2, 3 according to a first embodiment. The method can be performed using one of the apparatuses 1, 10-15 described above.

In a preparation step S0, one of the apparatuses 1, 10-15 described above is provided. In a step S1, data are exclusively transmitted from the first to the second network 2, 3 via the first one-way communication path 4 having the first data diode 6 and the encryption device 8. In a step S2, data are exclusively transmitted from the second network 3 to the first network 2 via the second one-way communication path 5 having the second data diode 7 and the decryption device 9.

Steps S1 and S2 can take place in parallel with one another or in succession. Step S2 can also be performed before step S1.

Although the present invention has been described on the basis of exemplary embodiments, it is modifiable in a wide variety of ways. The components arranged in the first one-way communication path 4 and in the second one-way communication path 5 can be chosen from the components described with reference to FIGS. 1 to 6 and can be combined other than in the manner described. The apparatuses 1, 10-15 described can be modified. For example, the apparatus 1 can have a bidirectional interface 23 that is arranged at the side of the second network 3.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. An apparatus for transmitting data between a first network and a second network, the apparatus comprising:
a first one-way communication path for exclusively transmitting data from the first network to the second network, having a first data diode and an encryption device for cryptographically encrypting the data to be transmitted from the first network to the second network; and
a second one-way communication path for exclusively transmitting data from the second network to the first network, having a second data diode and a decryption device for cryptographically decrypting the data to be transmitted from the second network to the first network.

2. The apparatus as claimed in claim 1, wherein the first one-way communication path and the second one-way communication path are physically and/or logically separate from one another.

3. The apparatus as claimed in claim 1, wherein the first data diode is connected in series upstream or connected in series downstream of the encryption device along the first one-way communication path; and/or
the second data diode is connected in series upstream or connected in series downstream of the decryption device along the second one-way communication path.

4. The apparatus as claimed in claim 1, wherein the first one one-way communication path comprises multiple first data diodes; and/or
the second one-way communication path comprises multiple second data diodes.

5. The apparatus as claimed in claim 4, wherein at least one first data diode the multiple first data diodes is connected in series upstream of the encryption device along the first one-way communication path and at least one further first data diode of the multiple first data diodes is connected in series downstream of the encryption device along the first one-way communication path; and/or
at least one second data diode of the multiple second data diodes is connected in series upstream of the decryption device along the second one-way communication path and at least one further second data diode of the multiple second data diodes is connected in series downstream of the decryption device along the second one-way communication path.

6. The apparatus as claimed in claim 1, further comprising at least one further encryption device, which is part of the first one-way communication path; and/or
at least one further decryption device, which is part of the second one-way communication path.

7. The apparatus as claimed in claim 6, wherein at least one first data diode is arranged in series between the two encryption devices; and/or at least one second data diode is arranged in series between the two decryption devices.

8. The apparatus as claimed in claim 1, wherein the first network is a private network; and/or the second network is a public network.

9. The apparatus as claimed in claim 1, further comprising a control device for setting up the encryption device and/or the decryption device.

10. The apparatus as claimed in claim 1, wherein the first one-way communication path comprises a first data handling device for handling the data transmitted from the first network to the second network; and/or
the second one-way communication path comprises a second data handling application for handling the data transmitted from the second network to the first network.

11. A method for transmitting data between a first network and a second network, the method comprising:
exclusively transmitting data from the first network to the second network via a first one-way communication path having a first data diode and an encryption device for cryptographically encrypting the data to be transmitted from the first network to the second network; and
exclusively transmitting data from the second network to the first network via a second one-way communication path having a second data diode and a decryption device for cryptographically decrypting the data to be transmitted from the second network to the first network.

12. The method as claimed in claim 11, wherein the method is performed using an apparatus.

13. A computer program product comprising a computer readable hardware storage device having computer readable program code stored therein, said program code executable by a processor of a computer system to implement the method as claimed in claim 11 on a program-controlled device.
